(19) United States
(12) Patent Application Publication
(10) Pub. No.: US 2025/0249691 A1
(43) Pub. Date: Aug. 7, 2025

(54) TAPE PRINTING APPARATUS AND METHOD FOR CONTROLLING TAPE PRINTING APPARATUS

(71) Applicant: SEIKO EPSON CORPORATION, Tokyo (JP)

(72) Inventors: Akio ISHIMOTO, Shiojiri-shi (JP); Tadashi INABA, Matsumoto-shi (JP)

(73) Assignee: SEIKO EP0SON CORPORATION, Tokyo (JP)

(21) Appl. No.: 19/045,832

(22) Filed: Feb. 5, 2025

(30) Foreign Application Priority Data
Feb. 6, 2024 (JP) 2024-016642

(51) Int. Cl. B41J 3/407; B41J 11/00; B41J 11/04; B41J 11/66; B41J 11/70; B41J 15/04

(52) U.S. Cl. CPC B41J 3/4075; B41J 11/0095; B41J 11/04; B41J 11/663; B41J 11/70; B41J 15/04

(57) ABSTRACT

A tape printing apparatus includes a print head that pinches a tape between the print head and a platen roller and performs printing on the tape to be fed in a first feeding direction, a cutter that is disposed further in the first feeding direction than the print head and cuts the tape in a width direction of the tape, an ejection roller that is disposed further in the first feeding direction than the cutter and feeds the tape toward a tape outlet in the first feeding direction, a feed motor that drives the platen roller, a cutter motor that drives the cutter, an ejection motor that drives the ejection roller, and a controller configured to control each motor. The controller is configured to drive the ejection motor in a period from when driving of the feed motor is stopped to when the tape is cut off by the cutter.

The present application is based on, and claims priority from JP Application Serial Number 2024-016642, filed Feb. 6, 2024, the disclosure of which is hereby incorporated by reference herein in its entirety.

### BACKGROUND

### 1. Technical Field

The present disclosure relates to a tape printing apparatus and a method for controlling the tape printing apparatus.

### 2. Related Art

In the related art, as disclosed in JP-A-2021-142753, a tape printing apparatus is known, which includes a print head that pinches a tape between the print head and a platen roller that feeds the tape in a forward feeding direction, and performs printing on the tape to be fed in the forward feeding direction, and a cutter that is disposed further in the forward feeding direction than the print head and cuts the tape in a width direction of the tape.

In this type of tape printing apparatus, when the tape end approaches, the trailing end of the tape is located between the print head and the cutter, and the tape is cut by the cutter, a tape piece having a length from a cut portion of the tape to the trailing end of the tape remains on a tape feeding path. When the tape piece remains on the tape feeding path, it may cause tape clogging. Thus an improvement measure is required.

### SUMMARY

According to an aspect of the present disclosure, a tape printing apparatus includes: a print head that pinches a tape between the print head and a platen roller that feeds the tape in a first feeding direction, and performs printing on the tape to be fed in the first feeding direction; a cutter that is disposed further in the first feeding direction than the print head and cuts the tape in a width direction of the tape; an ejection roller that is disposed further in the first feeding direction than the cutter and feeds the tape toward a tape outlet in the first feeding direction; a feed motor that drives the platen roller; a cutter motor that drives the cutter; an ejection motor that drives the ejection roller; and a controller configured to control the feed motor, the cutter motor, and the ejection motor. The controller is configured to drive the ejection motor such that the tape is ejected by the ejection roller in a period from when driving of the feed motor is stopped to when the tape is cut off by the cutter.

According to an aspect of the present disclosure, a method for controlling a tape printing apparatus that includes: a print head that pinches a tape between the print head and a platen roller that feeds the tape in a first feeding direction, and performs printing on the tape to be fed in the first feeding direction, a cutter that is disposed further in the first feeding direction than the print head and cuts the tape in a width direction of the tape, an ejection roller that is disposed further in the first feeding direction than the cutter and feeds the tape toward a tape outlet in the first feeding direction, a feed motor that drives the platen roller, a cutter motor that drives the cutter, and an ejection motor that drives the ejection roller, the tape printing apparatus controlling the feed motor, the cutter motor, and the ejection motor. The method includes causing the tape printing apparatus to drive the ejection motor such that the tape is ejected by the ejection roller in a period from when driving of the feed motor is stopped to when the tape is cut off by the cutter.

### BRIEF DESCRIPTION OF THE DRAWINGS

FIG. 1 is an external view of a tape printing apparatus and a tape cartridge.

FIG. 2 is a diagram illustrating the arrangement of members from a print head to a tape outlet in an X-axis direction.

FIG. 3 is a block diagram illustrating a hardware configuration of the tape printing apparatus.

FIG. 4 is a flowchart illustrating a printing process.

FIG. 5 is a graph illustrating changes in a rotation speed of a cutter motor and changes in an angle between blades of a full cutter.

### DESCRIPTION OF EMBODIMENTS

Hereinafter, a tape printing apparatus and a method for controlling the tape printing apparatus will be described with reference to the accompanying drawings. The tape printing apparatus 1 performs printing on a long tape T serving as a print medium while feeding the tape T, cuts a printed portion of the tape T, and ejects the cut tape T to the outside of the apparatus. Description will be made using directions based on an XYZ orthogonal coordinate system in some of the drawings, but these directions are merely for convenience of the description and do not limit the following embodiments in any way.

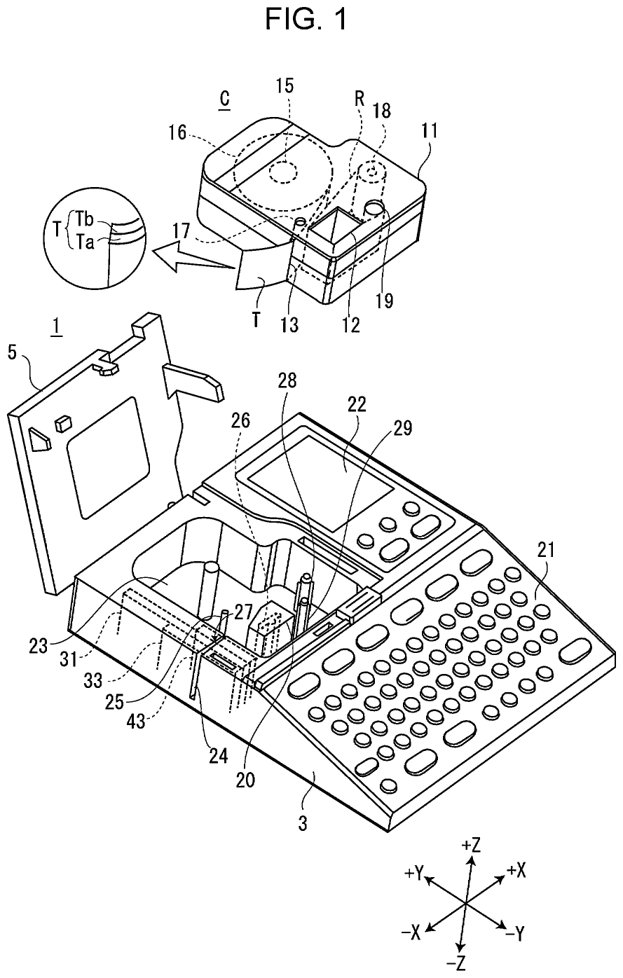

FIG. 1 is an external view of the tape printing apparatus 1 and a tape cartridge C. The tape printing apparatus 1 includes an apparatus case 3 and a mounting portion cover 5. An operation key group 21, a display 22, and a cartridge mounting portion 23 are disposed on a surface of the apparatus case 3 in a +Z direction.

The operation key group 21 receives various operations of a user, such as an operation of editing a print image to be printed on the tape T. The display 22 displays various kinds of information such as an edit screen of the print image. The tape printing apparatus 1 generates print data based on the operation of editing the print image by the user and performs a printing process based on the generated print data.

The cartridge mounting portion 23 is a recessed portion that is open in the +Z direction. The tape cartridge C is removably mounted on the cartridge mounting portion 23. The mounting portion cover 5 is rotatably mounted on an end portion of the apparatus case 3 in a +Y direction and opens and closes the cartridge mounting portion 23.

A print head 26 and a head cover 20 are disposed on the cartridge mounting portion 23. The print head 26 performs printing on the tape T. The head cover 20 partially covers the print head 26. A platen drive shaft 25, a feeding shaft 28, and a winding shaft 29 protrude in the +Z direction from a bottom surface of the cartridge mounting portion 23.

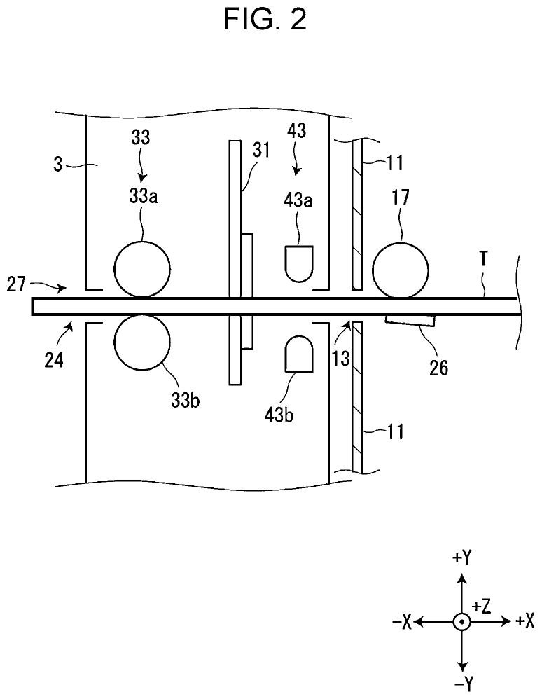

A tape outlet 24 communicating with the cartridge mounting portion 23 is formed in a side portion of the apparatus case 3 in a-X direction, and a tape feeding path 27 is formed between the cartridge mounting portion 23 and the tape outlet 24. As illustrated in FIG. 2, a sensor 43, a full cutter 31, and an ejection roller 33 are disposed from a +X direction in the apparatus case 3 so as to face the tape feeding path 27. The sensor 43 is an example of a “detecting section”. The full cutter 31 is an example of a “cutter”.

The sensor 43 detects the presence or absence of the tape T. The full cutter 31 cuts the tape T in the Z-axis direction. The ejection roller 33 feeds the tape T cut by the full cutter 31 toward the tape outlet 24.

The tape cartridge C includes a tape core 15, a platen roller 17, a feeding core 18, a winding core 19, and a cartridge case 11 that houses these components.

The tape T is wound around the tape core 15. The tape T includes a print tape Ta having an adhesive layer formed on a back surface of the print tape Ta and a release tape Tb adhering to the print tape Ta by the adhesive layer. The tape T is housed in the cartridge case 11 as a tape roll 16 wound around the tape core 15 with the print tape Ta on the outside and the release tape Tb on the inside. An ink ribbon R is wound around the feeding core 18. The ink ribbon R fed out of the feeding core 18 is wound around the winding core 19. The cartridge case 11 has a head insertion hole 12 penetrating the cartridge case 11 in the Z-axis direction. In addition, a tape feed outlet 13 extending in the Z-axis direction is disposed in a surface of the cartridge case 11 in the −X direction. The tape T fed out of the tape roll 16 is fed out of the cartridge case 11 through the tape feed outlet 13.

When the tape cartridge C is mounted on the cartridge mounting portion 23, the print head 26 and the head cover 20 are inserted in the head insertion hole 12. In addition, the platen drive shaft 25, the feeding shaft 28, and the winding shaft 29 engage with the platen roller 17, the feeding core 18, and the winding core 19, respectively. Subsequently, when the mounting portion cover 5 is closed, the print head 26 is moved toward the platen roller 17 by a head moving mechanism (not illustrated). Thus, the tape T and the ink ribbon R are pinched between the print head 26 and the platen roller 17.

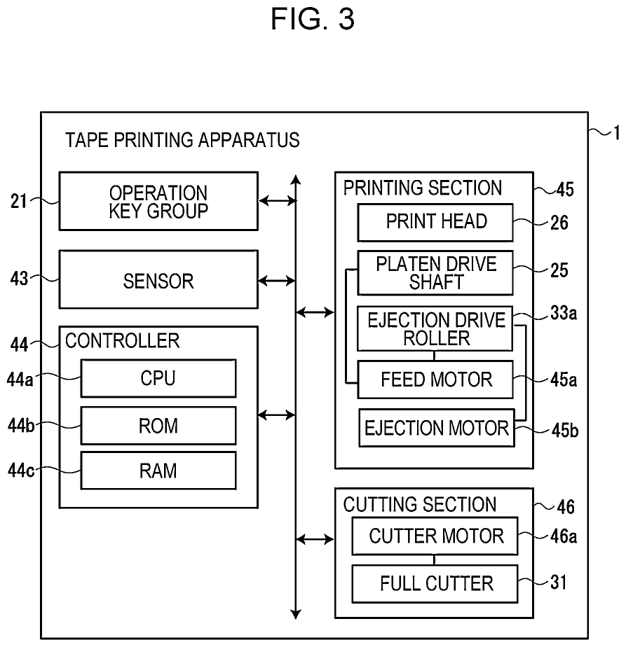

In this state, when a feed motor 45a illustrated in FIG. 3 rotates, the platen roller 17 rotates via the platen drive shaft 25, and the winding core 19 rotates via the winding shaft 29. As a result, the tape T is fed out of the cartridge case 11 through the tape feed outlet 13, and the ink ribbon R is wound around the winding core 19. When the feed motor 45a rotates, an ejection drive roller 33a illustrated in FIG. 2 also rotates in the same direction as the rotation direction of the platen roller 17. As a result, the tape T is fed toward the tape outlet 24 in the −X direction. The −X direction is an example of a “first feeding direction”.

The print head 26 generates heat according to the print data when the tape T is being fed in the −X direction. As a result, ink on the ink ribbon R is transferred to the tape T, and the print image based on the print data is printed on the tape T.

When the printing is completed, a rear end portion of a printed portion of the tape T is cut by the full cutter 31. The full cutter 31 cuts the print tape Ta and the peeling tape Tb of the tape T as a single tape piece. The full cutter 31 according to the present embodiment is a scissors-type cutter including a fixed blade which is a fixed member and a movable blade which is a movable member rotatably supported by the fixed blade via a support shaft. When the cutter motor 46a illustrated in FIG. 3 rotates in a first rotation direction, the movable blade of the full cutter 31 rotates in a direction approaching the fixed blade of the full cutter 31. That is, when the cutter motor 46a rotates in the first rotation direction, an angle between the fixed blade and the movable blade decreases. In addition, when the cutter motor 46a rotates in a second rotation direction opposite to the first rotation direction, the movable blade of the full cutter 31 rotates in a direction away from the fixed blade of the full cutter 31. That is, when the cutter motor 46a rotates in the second rotation direction, the angle between the fixed blade and the movable blade increases. The angle between the blades is not a cross-sectional angle between the blades included in the full cutter 31, but is an angle formed between a blade receiving surface of the fixed blade and a blade line of the movable blade as viewed from the rotation axis direction of the full cutter 31. The fixed blade and the movable blade constitute the full cutter 31.

After the tape T is cut by the full cutter 31, the tape T is fed by the ejection roller 33 toward the tape outlet 24 in the −X direction. When an ejection motor 45b illustrated in FIG. 3 rotates, the ejection drive roller 33a rotates. As a result, the tape T is fed in the −X direction and ejected from the tape outlet 24. In this way, a label on which a desired character or the like is printed on the strip-shaped tape T is produced.

Even when the ejection motor 45b rotates, the platen roller 17 does not rotate. That is, after the operation of cutting the tape T is ended, the tape printing apparatus 1 drives the ejection motor 45b to rotate the ejection drive roller 33a without rotating the platen roller 17. During printing, the tape printing apparatus 1 drives the feed motor 45a to rotate the platen roller 17 and the ejection drive roller 33a.

The tape printing apparatus 1 according to the present embodiment rotates the ejection motor 45b not only during printing or after the operation of cutting the tape T is ended, but also in a period from when the driving of the cutter motor 46a is started until before a cut is made in the tape T by the full cutter 31 after the end of the printing of the tape T. Details will be described later. The arrangement of members from the print head 26 to the tape outlet 24 in the X-axis direction will be described with reference to FIG. 2. FIG. 2 illustrates the arrangement of the members in a state in which the tape cartridge C is mounted on the cartridge mounting portion 23. Therefore, the platen roller 17 housed in the cartridge case 11 of the tape cartridge C is disposed at a position facing the print head 26 with the tape T interposed therebetween. In addition, the tape feed outlet 13 of the cartridge case 11 is located further in the −X direction than a printing position of the print head 26.

The full cutter 31 is disposed further in the −X direction than the platen roller 17. The position of the platen roller 17 in the X-axis direction corresponds to the printing position of the print head 26.

The ejection roller 33 is disposed further in the −X direction than the full cutter 31 and is disposed further in the +X direction than the tape outlet 24. The ejection roller 33 includes the ejection drive roller 33a and an ejection driven roller 33b. The ejection roller 33 pinches the tape T between the ejection drive roller 33a and the ejection driven roller 33b and feeds the tape T toward the tape outlet 24 in the −X direction.

The sensor 43 is disposed between the platen roller 17 and the full cutter 31. That is, the detection position of the sensor 43 is located further in the −X direction than the printing position of the print head 26 and is located further in the +X direction than the cutting position of the full cutter 31. The sensor 43 is constituted by a transmissive optical sensor and includes a light emitting device 43a and a light receiving device 43b which are arranged to face each other with the tape T interposed therebetween.

A hardware configuration of the tape printing apparatus 1 will be described with reference to FIG. 3. The tape printing apparatus 1 includes the operation key group 21, the sensor 43, a controller 44, a printing section 45, and a cutting section 46.

The operation key group 21 includes a print key in addition to character keys and numeric keys. The print key is a key for the user to instruct the start of printing. When the user operates the print key, the controller 44 acquires a print start command and starts the printing process.

The sensor 43 detects the presence or absence of the tape T. The sensor 43 detects the “absence of the tape” when the sensor 43 is in a light receiving state, and detects the “presence of the tape” when the sensor 43 is in a light blocking state. The sensor 43 is used to detect that the leading end of the tape T has passed through a detection position and to detect a tape end. The tape end indicates that the trailing end of the tape T has passed through the detection position of the sensor 43.

The controller 44 controls each section in the tape printing apparatus 1 and includes a central processing unit (CPU) 44a, a read-only memory (ROM) 44b, and a random-access memory (RAM) 44c.

The CPU 44a performs various kinds of control by loading a control program such as firmware stored in the ROM 44b into the RAM 44c and executing the control program. The controller 44 may use a hardware circuit such as an ASIC as a processor instead of the CPU 44a. Furthermore, the processor may have a configuration in which one or more CPUs and a hardware circuit such as an ASIC operate in cooperation with each other.

The printing section 45 includes the print head 26, the platen drive shaft 25, the ejection drive roller 33a, the feed motor 45a, and the ejection motor 45b.

The print head 26 includes a heating element group (not illustrated) and performs printing by thermally transferring the ink from the ink ribbon R to the tape T. The heating element group is a plurality of heating elements arranged in the Z-axis direction.

The platen drive shaft 25 engages with the platen roller 17 to rotate the platen roller 17. The ejection drive roller 33a pinches the tape T between the ejection drive roller 33a and the ejection driven roller 33b and feeds the tape T toward the tape outlet 24.

As described above, the feed motor 45a is a drive source of the platen drive shaft 25 and the ejection drive roller 33a. As described above, the ejection motor 45b is a drive source of the ejection drive roller 33a. In the present embodiment, the feed motor 45a is a stepping motor. Furthermore, the ejection motor 45b is a direct current (DC) motor.

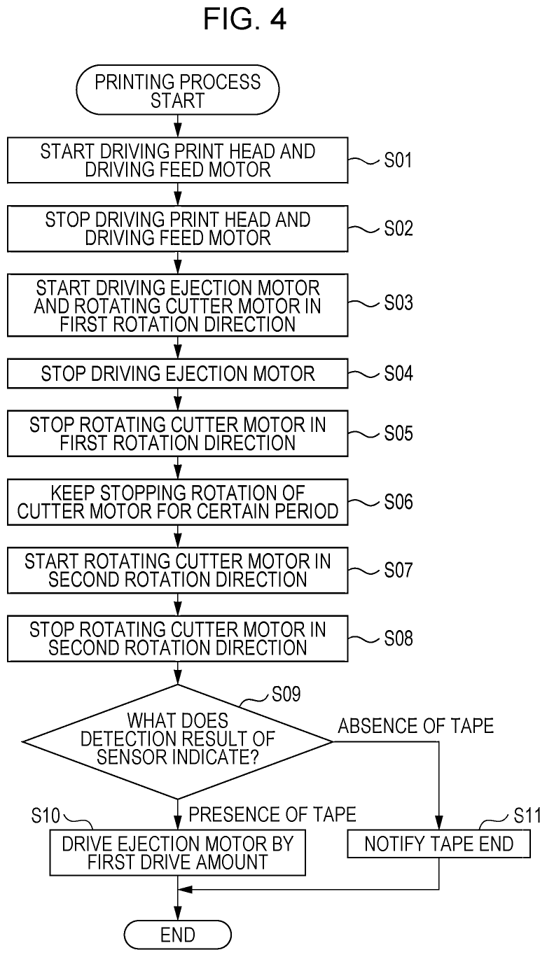

The feed motor 45a rotates from the start to the end of the feeding of the tape T in the −X direction, and the ejection motor 45b rotates after the end of the feeding of the tape T in the −X direction. The end of the feeding of the tape T in the −X direction refers to, for example, the end of the feeding of the tape T in the −X direction by a margin area of a label after the end of the driving of the print head 26 when the label having the margin area in the +X direction of the tape T, that is, on the rear end side is to be produced. In addition, the printing process refers to a series of steps illustrated in FIG. 4 up to the cutting of the tape T and the ejection of the cut tape T after the end of the feeding of the tape T in the −X direction.

The cutting section 46 includes the cutter motor 46a and the full cutter 31. The cutter motor 46a is a drive source that drives the full cutter 31. In the present embodiment, the cutter motor 46a is a DC motor. When the cutter motor 46a rotates, the cutter 31 operates and the tape T is cut in the Z-axis direction.

Functions of the controller 44 will be described. The controller 44 drives the ejection motor 45b such that the tape T is ejected by the ejection roller 33 in a period from when the driving of the feed motor 45a is stopped to when the tape T is cut off by the full cutter 31.

Accordingly, when the tape end approaches, the driving of the feed motor 45a is stopped, and the trailing end of the tape T is located between the print head 26 and the full cutter 31, the tape printing apparatus 1 can eject the tape T before the tape T is cut off by the full cutter 31. As a result, the tape printing apparatus 1 does not cut off the tape T by the full cutter 31 when the trailing end of the tape T is located between the print head 26 and the full cutter 31, and thus the tape printing apparatus 1 can prevent or reduce occurrence of a piece of the tape T remaining on the tape feeding path 27.

In the present embodiment, the controller 44 drives the ejection motor 45b in a period from when the driving of the cutter motor 46a is started until before a cut is made in the tape T by the full cutter 31. The “driving of the cutter motor 46a” refers to the rotation of the cutter motor 46a in the first rotation direction. As described above, since the tape printing apparatus 1 drives the ejection motor 45b during the driving of the cutter motor 46a, the time for operating the full cutter 31 can be used for the ejection of the tape T. In addition, since the tape printing apparatus 1 stops driving the ejection motor 45b before a cut is made in the tape T by the full cutter 31, the tape printing apparatus 1 can prevent or reduce occurrence of the tape T being ejected by the driving of the ejection motor 45b while being cut and occurrence of the cut surface of the tape T being disturbed.

The making of the cut in the tape T indicates that the blades of the full cutter 31 come into contact with the tape T and the cut is made in the tape T. The cutting off of the tape T indicates that the blades of the full cutter 31 are closed and the tape T is divided into two.

In addition, when the “absence of the tape” is detected by the sensor 43 after the driving of the ejection motor 45b is started, the controller 44 causes the display 22 to display a message indicating the tape end. The display 22 is an example of a “notification section”. Furthermore, displaying the message indicating the tape end is an example of “causing a notification section to notify a tape end”. Thus, the user can know the tape end. In the present embodiment, the controller 44 determines the detection result of the sensor 43 after the end of the cutting by the full cutter 31, and causes the display 22 to display the message indicating the tape end when the controller 44 determines that the detection result of the sensor 43 indicates the “absence of the tape”.

In addition, after the tape T is cut off, when the “presence of the tape” is detected by the sensor 43, the controller 44 drives the ejection motor 45b. Thus, the tape printing apparatus 1 can prevent or reduce the tape T remaining in the vicinity of the tape outlet 24. In the present embodiment, the controller 44 determines the detection result of the sensor 43 after the end of the cutting by the full cutter 31, and drives the ejection motor 45b when the controller 44 determines that the detection result of the sensor 43 indicates the “presence of the tape”.

A procedure of the printing process by the tape printing apparatus 1 will be described with reference to a flowchart of FIG. 4. The printing process by the tape printing apparatus 1 is an example of a “method for controlling a tape printing apparatus”. The printing process is started when the tape printing apparatus 1 acquires the print start command. As described above, when the tape printing apparatus 1 acquires the print start command, the tape printing apparatus 1 generates print data based on a result of editing a print image by the user. The printing process described below is performed based on the print data.

In step S01, the tape printing apparatus 1 starts driving the print head 26 and driving the feed motor 45a. That is, in step S01, the tape printing apparatus 1 starts printing.

In step S02, the tape printing apparatus 1 stops driving the print head 26 and driving the feed motor 45a. That is, in step S02, the tape printing apparatus 1 ends the printing.

In step S03, the tape printing apparatus 1 starts driving the ejection motor 45b and rotating the cutter motor 46a in the first rotation direction. After step S03, the full cutter 31 starts closing along the rotation of the cutter motor 46a in the first rotation direction.

In step S04, the tape printing apparatus 1 stops driving the ejection motor 45b. More specifically, the tape printing apparatus 1 stops driving the ejection motor 45b upon ending the deceleration of the rotation of the cutter motor 46a in the first rotation direction. When the trailing end of the tape T is located between the print head 26 and the full cutter 31 in step S02, the tape T is ejected between step S03 and step S04.

In step S05, the tape printing apparatus 1 stops rotating the cutter motor 46a in the first rotation direction. When the tape T is not ejected before step S04, the tape T is cut after the driving of the ejection motor 45b is stopped in step S04 and before the rotation of the cutter motor 46a in the first rotation direction is stopped in step S05. That is, when the tape T is not ejected before step S04, the cutting of the tape T is performed from when the cut is made in the tape T to when the tape T is cut off between step S04 and step S05.

In step S06, the tape printing apparatus 1 keeps stopping the rotation of the cutter motor 46a for a certain period. At this time, the rotation direction of the cutter motor 46a is reversed.

In step S07, the tape printing apparatus 1 starts rotating the cutter motor 46a in the second rotation direction. After step S07, the full cutter 31 is opened by the rotation of the cutter motor 46a in the second rotation direction.

In step S08, the tape printing apparatus 1 stops rotating the cutter motor 46a in the second rotation direction.

In step S09, the tape printing apparatus 1 determines the detection result of the sensor 43. When the tape printing apparatus 1 determines that the detection result of the sensor 43 indicates the “presence of the tape”, the process proceeds to step S10. When the tape printing apparatus 1 determines that the detection result of the sensor 43 indicates the “absence of the tape”, the process proceeds to step S11.

In step S10, the tape printing apparatus 1 drives the ejection motor 45b by a first drive amount. The first drive amount is stored as part of control data in the ROM 44b. The first drive amount refers to the amount of rotation of the ejection motor 45b. Furthermore, the first drive amount is a drive amount that allows the tape T cut by the full cutter 31 to be reliably ejected from the tape outlet 24. Thus, the tape T cut by the full cutter 31 is fed toward the tape outlet 24. After step S10, the tape printing apparatus 1 ends the printing process.

In step S11, the tape printing apparatus 1 notifies the tape end. More specifically, the tape printing apparatus 1 causes the display 22 to display the message indicating the tape end. After step S11, the tape printing apparatus 1 ends the printing process.

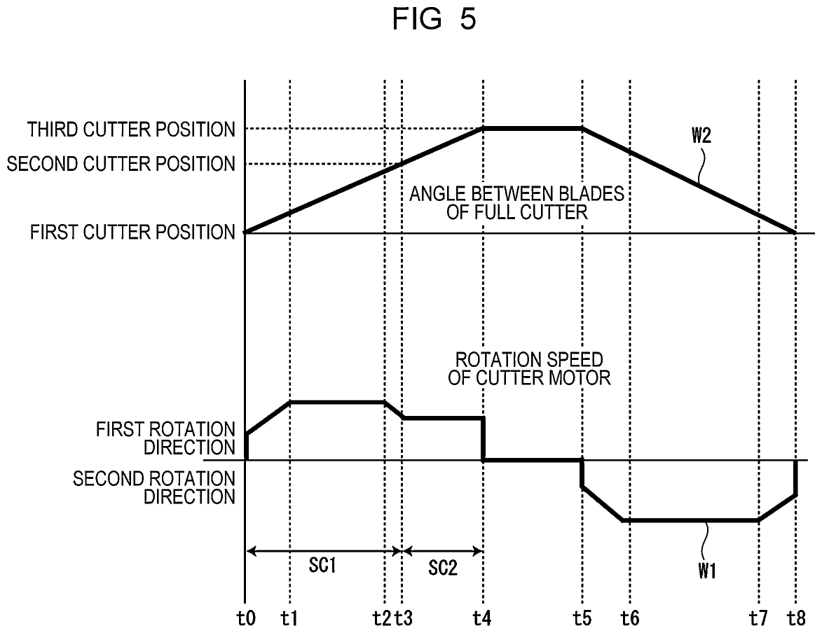

The drive control of the cutter motor 46a will be described with reference to FIG. 5. FIG. 5 is a graph illustrating changes in the rotation speed of the cutter motor 46a and changes in the angle between the blades of the full cutter 31. In FIG. 5, a first thick line W1 indicates the changes in the rotation speed of the cutter motor 46a and a second thick line W2 indicates the changes in the angle between the blades of the full cutter 31. In a graph of the rotation speed of the cutter motor 46a, the upper side of the horizontal axis indicates the rotation speed when the cutter motor 46a rotates in the first rotation direction, and the lower side of the horizontal axis indicates the rotation speed when the cutter motor 46a rotates in the second rotation direction. In addition, a graph of the angle between the blades of the full cutter 31 indicates that the angle between the blades decreases toward the top of the graph. FIG. 5 illustrates the changes in the rotation speed of the cutter motor 46a and the changes in the angle between the blades of the full cutter 31 from the start of the rotation of the cutter motor 46a in the first rotation direction, i.e., step S03 in FIG. 4, to the stop of the rotation in the second rotation direction, i.e., step S08 in FIG. 4.

As indicated by the first thick line W1, the tape printing apparatus 1 increases the rotation speed of the cutter motor 46a in the first rotation direction from time t0 to time t1 and maintains the rotation speed of the cutter motor 46a in the first rotation direction from time t1 to time t2. In addition, the tape printing apparatus 1 reduces the rotation speed of the cutter motor 46a in the first rotation direction from time t2 to time t3 and maintains the rotation speed of the cutter motor 46a in the first rotation direction from time t3 to time t4. At time t4, as illustrated in step S05 in FIG. 4, the tape printing apparatus 1 stops rotating the cutter motor 46a in the first rotation direction.

A first period SC1, which is a period from time to to time t3, indicates a period for which the ejection motor 45b is driven. That is, at time to, as illustrated in step S03 in FIG. 4, the driving of the ejection motor 45b is started. At time t3, as illustrated in step S04 in FIG. 4, the driving of the ejection motor 45b is stopped. A second period SC2, which is a period from time t3 to time t4, indicates a period for which the tape T is cut. That is, at time t4, the tape T is cut off.

As illustrated in step S06 in FIG. 4, the tape printing apparatus 1 keeps stopping the rotation of the cutter motor 46a from time t4 to time t5. As illustrated in step S07 in FIG. 4, the tape printing apparatus 1 starts rotating the cutter motor 46a in the second rotation direction at time t5 and increases the rotation speed of the cutter motor 46a in the second rotation direction from time t5 to time t6. The tape printing apparatus 1 maintains the rotation speed of the cutter motor 46a in the second rotation direction from time t6 to time t7 and decreases the rotation speed of the cutter motor 46a in the second rotation direction from time t7 to time t8. At time t8, as illustrated in step S08 in FIG. 4, the tape printing apparatus 1 stops rotating the cutter motor 46a in the second rotation direction.

As indicated by the second thick line W2, the tape printing apparatus 1 decreases the angle between the blades of the full cutter 31 from time t0 to time t4. The tape printing apparatus 1 maintains the angle between the blades of the full cutter 31 from time t4 to time t5. The tape printing apparatus 1 increases the angle between the blades of the full cutter 31 from time t5 to time t8.

The first period SC1 and the second period SC2 are described below based on the position of the movable blade of the full cutter 31 relative to the fixed blade of the full cutter 31. The position of the movable blade relative to the position of the fixed blade at time to is referred to as a first cutter position, the position of the movable blade relative to the position of the fixed blade at time t3 is referred to as a second cutter position, and the position of the movable blade relative to the position of the fixed blade at time t4 is referred to as a third cutter position. The tape printing apparatus 1 drives the ejection motor 45b while the full cutter 31 moves from the first cutter position to the second cutter position. The tape T is cut while the full cutter 31 moves from the second cutter position to the third cutter position. In other words, the second cutter position is a cutter position at which a cut is made in the tape T by the full cutter 31. The third cutter position is a cutter position at which the tape T is cut off by the full cutter 31.

As described above, the tape printing apparatus 1 according to the present embodiment drives the ejection motor 45b in a period from when the driving of the cutter motor 46a is started until before a cut is made in the tape T by the full cutter 31. For this reason, when the tape end approaches, the driving of the feed motor 45a is stopped, and the trailing end of the tape T is located between the print head 26 and the full cutter 31, the tape printing apparatus 1 can eject the tape T before the tape T is cut off by the full cutter 31. Accordingly, the tape printing apparatus 1 does not cut off the tape T by the full cutter 31 when the trailing end of the tape T is located between the print head 26 and the full cutter 31, and the tape printing apparatus 1 can prevent or reduce occurrence of a piece of the tape remaining on the tape feeding path 27.

In addition, since the tape printing apparatus 1 starts driving the ejection motor 45b at the same time as the start of the driving of the cutter motor 46a, the control is easy and the tape printing apparatus 1 can eject the tape T using the time for operating the full cutter 31.

In addition, since the tape printing apparatus 1 stops driving the ejection motor 45b before the cut is made in the tape T by the full cutter 31, the tape printing apparatus 1 can prevent or reduce occurrence of the tape T being ejected by the driving of the ejection motor 45b while being cut by the full cutter 31 and occurrence of the cut surface of the tape T being disturbed.

In addition, since the tape printing apparatus 1 notifies the tape end when the “absence of the tape” is detected by the sensor 43 after the driving of the cutter motor 46a is stopped, the tape printing apparatus 1 can notify the user of the tape end.

In addition, since the tape printing apparatus 1 drives the ejection motor 45b when the “presence of the tape” is detected by the sensor 43 after the driving of the cutter motor 46a is stopped, the tape printing apparatus 1 can prevent or reduce occurrence of the tape T remaining in the vicinity of the tape outlet 24.

The present disclosure is not limited to the above embodiment, and the following modifications can be adopted.

### Modification 1

The tape printing apparatus 1 does not necessarily start driving the ejection motor 45b and rotating the cutter motor 46a in the first rotation direction at the same time. For example, the tape printing apparatus 1 may start driving the ejection motor 45b before or after the start of the rotation of the cutter motor 46a in the first rotation direction.

### Modification 2

In addition, the tape printing apparatus 1 may start rotating the cutter motor 46a in the first rotation direction after stopping driving the ejection motor 45b. In this case, the tape printing apparatus 1 may drive the ejection motor 45b after stopping driving the print head 26 and driving the feed motor 45a and start rotating the cutter motor 46a in the first rotation direction after stopping driving the ejection motor 45b.

### Modification 3

Instead of stopping driving the ejection motor 45b when the deceleration of the rotation of the cutter motor 46a in the first rotation direction is ended, the tape printing apparatus 1 may stop driving the ejection motor 45b when the rotation speed of the cutter motor 46a in the first rotation direction is constant after the acceleration of the rotation of the cutter motor 46a in the first rotation direction, or may stop driving the ejection motor 45b during the deceleration of the rotation of the cutter motor 46a in the first rotation direction. That is, in the example illustrated in FIG. 5, the tape printing apparatus 1 may stop driving the ejection motor 45b between time t1 and time t2 or between time t2 and time t3.

### Modification 4

Instead of determining the detection result of the sensor 43 after the rotation of the cutter motor 46a in the second rotation direction is stopped, the tape printing apparatus 1 may determine the detection result of the sensor 43 in a period from when the driving of the ejection motor 45b is started to when the rotation of the cutter motor 46a in the second rotation direction is stopped. That is, in the example illustrated in FIG. 5, the tape printing apparatus 1 may determine the detection result of the sensor 43 in the period from time t0 to time t8. When the tape printing apparatus 1 determines that the detection result of the sensor 43 indicates the “absence of the tape” in the period, the tape printing apparatus 1 may notify the tape end without waiting for the stop of the rotation of the cutter motor 46a in the second rotation direction.

### Modification 5

The tape printing apparatus 1 may determine the detection result of the sensor 43 in a period from when the tape T is cut off to when the rotation of the cutter motor 46a in the second rotation direction is stopped. That is, in the example illustrated in FIG. 5, since the tape printing apparatus 1 cuts off the tape T in the second period SC2, the detection result of the sensor 43 may be determined in the period from time t4 to time t8. The tape printing apparatus 1 may drive the ejection motor 45b without waiting for the stop of the rotation of the cutter motor 46a in the second rotation direction when the tape printing apparatus 1 determines that the detection result of the sensor 43 indicates the “presence of the tape” in the period.

### Modification 6

The tape printing apparatus 1 may include a common motor which is a common drive motor instead of including the feed motor 45a and the ejection motor 45b. In this case, the common motor functions as a “feed motor” and an “ejection motor”. For example, it is assumed that the common motor is rotatable in the first rotation direction and the second rotation direction opposite to the first rotation direction. In this case, the tape printing apparatus 1 may be configured to rotate the platen roller 17 and the ejection drive roller 33a by rotating the common motor in the first rotation direction, and to rotate the ejection drive roller 33a by rotating the common motor in the second rotation direction without rotating the platen roller 17.

### Modification 7

The tape printing apparatus 1 may control the ejection motor 45b according to the above-described embodiment even when the tape T is to be cut after the tape T is fed in the −X direction without the driving of the print head 26. For example, when the tape printing apparatus 1 has a function of producing the tape T that has a predetermined length and on which printing is not performed, it is considered that the tape printing apparatus 1 performs the feeding of the tape T in the −X direction and the cutting of the tape T upon being instructed by the user to execute the function. As described above, even when the tape printing apparatus 1 does not acquire the print start command, the tape printing apparatus 1 can control the ejection motor 45b according to the above-described embodiment.

Furthermore, the tape printing apparatus 1 may be a printing apparatus of a pick-and-print type in which the next printing process is started when the user pulls out the cut tape T as a trigger.

### Modification 8

The tape printing apparatus 1 may notify the tape end by using an audio output section. In this case, the audio output section is an example of the “notification section”. In addition, the tape printing apparatus 1 may notify the tape end by using a light emitter such as an LED. In this case, the light emitter is an example of the “notification section”.

### Modification 9

The ejection motor 45b and the cutter motor 46a are not limited to the DC motors and may be other drive motors such as stepping motors. The feed motor 45a is not limited to the stepping motor and may be another drive motor such as a DC motor.

### Modification 10

The full cutter 31 may be a cutter in which the movable blade slides with respect to the fixed blade instead of rotating with respect to the fixed blade. In this case, the angle between the blades of the full cutter 31 is not changed by the control of the cutter motor 46a, but the interval between the movable blade and the fixed blade is changed.

### Modification 11

The sensor 43 may be disposed between the full cutter 31 and the tape outlet 24 instead of being disposed between the print head 26 and the full cutter 31.

In addition, the sensor 43 may be a reflective optical sensor instead of being the transmissive optical sensor.

Furthermore, the presence or absence of the tape T may be detected by a mechanical switch instead of the sensor 43. The mechanical switch is an example of the “detecting section”. In this case, the mechanical switch outputs a signal indicating the “presence of the tape” when a distal end of the mechanical switch is in contact with the tape T, and outputs a signal indicating the “absence of the tape” when the distal end of the mechanical switch is not in contact with the tape T.

Furthermore, the presence or absence of the tape T may be detected by a pinching sensor for detecting whether or not the tape T is pinched between the ejection drive roller 33a and the ejection driven roller 33b. The pinching sensor is an example of the “detecting section”. In this case, the pinching sensor outputs a signal indicating the “presence of the tape” when the tape T is pinched between the ejection drive roller 33a and the ejection driven roller 33b, and outputs a signal indicating the “absence of the tape” when the tape T is not pinched between the ejection drive roller 33a and the ejection driven roller 33b.

### Modification 12

The tape printing apparatus 1 does not necessarily have the configuration in which the tape cartridge C is mountable. For example, the tape printing apparatus 1 may include a platen roller, or may perform printing on the tape T supplied from the outside of the tape printing apparatus 1.

### Modification 13

The firmware of the tape printing apparatus 1 may be provided to a customer as a program. Alternatively, a storage medium in which the firmware of the tape printing apparatus 1 is recorded may be provided to the customer. In addition, appropriate changes can be made without departing from the gist of the present disclosure.

### Supplementary Notes

Hereinafter, the tape printing apparatus and the method for controlling the tape printing apparatus will be additionally described.

The tape printing apparatus 1 includes: the print head 26 that pinches the tape T between the print head 26 and the platen roller 17 that feeds the tape T in the −X direction, and performs printing on the tape T to be fed in the −X direction; the full cutter 31 that is disposed further in the −X direction than the print head 26 and cuts the tape T in a width direction of the tape T; the ejection roller 33 that is disposed further in the −X direction than the full cutter 31 and feeds the tape T toward the tape outlet 24 in the −X direction; the feed motor 45a that drives the platen roller 17; the cutter motor 46a that drives the full cutter 31; the ejection motor 45b that drives the ejection roller 33; and the controller 44 configured to control the feed motor 45a, the cutter motor 46a, and the ejection motor 45b. The controller 44 is configured to drive the ejection motor 45b such that the tape T is ejected by the ejection roller 33 in a period from when the driving of the feed motor 45a is stopped to when the tape T is cut off by the full cutter 31.

The method for controlling the tape printing apparatus 1 that includes: the print head 26 that pinches the tape T between the print head 26 and the platen roller 17 that feeds the tape T in the −X direction, and performs printing on the tape T to be fed in the −X direction; the full cutter 31 that is disposed further in the −X direction than the print head 26 and cuts the tape T in the width direction of the tape T; the ejection roller 33 that is disposed further in the −X direction than the full cutter 31 and feeds the tape T toward the tape outlet 24 in the −X direction; the feed motor 45a that drives the platen roller 17; the cutter motor 46a that drives the full cutter 31; and the ejection motor 45b that drives the ejection roller 33, and the tape printing apparatus 1 controlling the feed motor 45a, the cutter motor 46a, and the ejection motor 45b includes causing the tape printing apparatus 1 to drive the ejection motor 45b such that the tape T is ejected by the ejection roller 33 in a period from when the driving of the feed motor 45a is stopped to when the tape T is cut off by the full cutter 31.

According to this configuration, the tape printing apparatus 1 drives the ejection motor 45b in a period until the tape T is cut off after the driving of the feed motor 45a is stopped. For this reason, when the tape end approaches, the driving of the feed motor 45a is stopped, and the trailing end of the tape T is located between the print head 26 and the full cutter 31, the tape printing apparatus 1 can eject the tape T before the tape T is cut off by the full cutter 31. Thus, the tape printing apparatus 1 can prevent or reduce a piece of the tape remaining on the feeding path.

In the tape printing apparatus 1 described above, it is preferable that the controller 44 be configured to drive the ejection motor 45b in a period from when the driving of the cutter motor 46a is started until the tape T is cut off.

According to this configuration, the tape printing apparatus 1 can use the time for operating the full cutter 31 for the ejection of the tape T.

In the above-described tape printing apparatus 1, it is preferable that the controller 44 be configured to stop the driving of the ejection motor 45b before a cut is made in the tape T by the full cutter 31.

According to this configuration, the tape printing apparatus 1 can prevent or reduce occurrence of the tape T being ejected by the driving of the ejection motor 45b while being cut by the full cutter 31 and occurrence of the cut surface of the tape T being disturbed.

It is preferable that the tape printing apparatus 1 described above further include the sensor 43 that is disposed between the print head 26 and the tape outlet 24 and detects the presence or absence of the tape T, and that the controller 44 be configured to cause the notification section to notify the tape end when the absence of the tape is detected by the sensor 43 after the driving of the ejection motor 45b is started.

According to this configuration, the tape printing apparatus 1 can notify the user of the tape end.

It is preferable that the tape printing apparatus 1 described above further include the sensor 43 that is disposed between the print head 26 and the tape outlet 24 and detects the presence or absence of the tape T, and that the controller 44 be configured to drive the ejection motor 45b when the presence of the tape T is detected by the sensor 43 after the tape T is cut off.

According to this configuration, since the tape printing apparatus 1 drives the ejection motor 45b after the tape T is cut off, the tape printing apparatus 1 can prevent or reduce occurrence of the tape T remaining in the vicinity of the tape outlet 24.

What is claimed is:

1. A tape printing apparatus comprising:
a print head that pinches a tape between the print head and a platen roller that feeds the tape in a first feeding direction, and performs printing on the tape to be fed in the first feeding direction;
a cutter that is disposed further in the first feeding direction than the print head and cuts the tape in a width direction of the tape;
an ejection roller that is disposed further in the first feeding direction than the cutter and feeds the tape toward a tape outlet in the first feeding direction;
a feed motor that drives the platen roller;
a cutter motor that drives the cutter;
an ejection motor that drives the ejection roller; and
a controller configured to control the feed motor, the cutter motor, and the ejection motor, wherein
the controller is configured to drive the ejection motor such that the tape is ejected by the ejection roller in a period from when driving of the feed motor is stopped to when the tape is cut off by the cutter.

2. The tape printing apparatus according to claim 1, wherein the controller is configured to drive the ejection motor in a period from when driving of the cutter motor is started to when the tape is cut off.

3. The tape printing apparatus according to claim 1, wherein the controller is configured to stop driving of the ejection motor before a cut is made in the tape by the cutter.

4. The tape printing apparatus according to claim 1, further comprising a detecting section that is disposed between the print head and the tape outlet and detects presence or absence of the tape, wherein
the controller is configured to cause a notification section to notify a tape end when the absence of the tape is detected by the detecting section after driving of the ejection motor is started.

5. The tape printing apparatus according to claim 3, further comprising a detecting section that is disposed between the print head and the tape outlet and detects presence or absence of the tape, wherein
the controller is configured to drive the ejection motor when the presence of the tape is detected by the detecting section after the tape is cut off.

6. A method for controlling a tape printing apparatus that includes
a print head that pinches a tape between the print head and a platen roller that feeds the tape in a first feeding direction, and performs printing on the tape to be fed in the first feeding direction,
a cutter that is disposed further in the first feeding direction than the print head and cuts the tape in a width direction of the tape,
an ejection roller that is disposed further in the first feeding direction than the cutter and feeds the tape toward a tape outlet in the first feeding direction,
a feed motor that drives the platen roller,
a cutter motor that drives the cutter, and
an ejection motor that drives the ejection roller, the tape printing apparatus controlling the feed motor, the cutter motor, and the ejection motor, the method comprising:
causing the tape printing apparatus to drive the ejection motor such that the tape is ejected by the ejection roller in a period from when driving of the feed motor is stopped to when the tape is cut off by the cutter.
